(19) United States
(12) Patent Application Publication
(10) Pub. No.: US 2009/0258325 A1
(43) Pub. Date: Oct. 15, 2009

(54) Separator apparatus

(76) Inventor: Farnaz Zand, Burbank, CA (US)

Correspondence Address: JAMES E. BRUNTON, ESQ., P. O. BOX 29000, GLENDALE, CA, 91209, US

(21) Appl. No.: 12/082,374

(22) Filed: Apr. 10, 2008

(51) Int. Cl. A61C 7/10

(52) U.S. Cl. 433/149

(57) ABSTRACT

A separator apparatus for separating a pair of adjacent teeth of a patient to facilitate the later placement of a molar band between the teeth. The apparatus includes a separator unit and a cooperating separating mechanism for manipulating the separator unit. The separator unit includes a length of separator material having a first coiled end portion, a second coiled end portion and an intermediate portion; the first and second coiled end portions being movable by the separating mechanism from a first at rest position to a second, spaced apart partially uncoiled position.

### FIELD OF THE INVENTION

The present invention relates generally to dental tools. More particularly the invention concerns a separator apparatus for separating pairs of adjacent teeth of a patient to facilitate the later placement of an anchor molar band between the teeth.

### DISCUSSION OF THE PRIOR ART

Orthodontic practitioners have long used generally torus-shaped, elastomeric ring modules to move patient's teeth away from each other in order to enable the placement of metal bands around molar teeth. Typically, these elastomeric rings are positioned between the patient's teeth using a pliers-like device that functions to suitably stretch the ring and force it between the teeth and the gum line. When the ring is properly in position, the pliers like device is removed and the ring is allowed to recover its original shape and thickness.

One of the major problems concerning the use of these prior art elastomeric ring modules resides in the fact that, since the separation process takes place over several days time, occasionally these modules are gone or appear to be gone when patients return to the practitioner. This results because the prior art ring modules are typically constructed from plastics that are not well-suited for long-term in vivo applications. In the past, this problem has sometimes been addressed by the introduction of radio-opaque materials into the plastics from which the modules are made so that if the module appears to be missing the practitioner can use radiography to produce an image of the suspect area in the mouth and then use a surgical process to recover the module if it is still in place.

Exemplary of one form of prior art ring shaped separator module is the module described in U.S. Pat. No. 6,988,887 issued to Hanson et al. The Hanson et al. invention features an orthodontic separator that can be used to separate a pair of adjacent teeth in a patient's mouth. The invention also features a method for separating adjacent teeth using the separator. The separator is dimensioned such that it can be inserted between adjacent teeth and is characterized in that when inserted between adjacent teeth in the oral environment, it exhibits an increase in compressive force. The Hanson et al. orthodontic separator can be designed to expand isotropically or anisotropically. It can also continue to expand over time, exerting a compressive force on the adjacent teeth despite the widening gap between the teeth and decay, resulting from relaxation of the separator.

### SUMMARY OF THE INVENTION

By way of summary, the present invention concerns a novel separator apparatus for separating a pair of adjacent teeth of a patient to facilitate the later placement of a molar band between the teeth. In one form of the invention, the apparatus comprises a separator unit and a cooperating separating mechanism for manipulating the separator unit. The separator unit comprises a length of separator material having a first coiled end portion, a second coiled end portion and an intermediate portion; the first and second coiled end portions being movable from a first at rest position to a second, spaced apart partially uncoiled position. The separator mechanism, which functions to move the first and second coiled end portions of the separator unit from the first position to the second position, comprises a gripping portion, a first outwardly extending arm connected to the gripping portion, the first arm being releasably engagable with the first coiled end portion of the separator unit and a second arm pivotally connected to the first arm for movement between first and second positions, the second arm being releasably engagable with the second coiled end portion of the separator unit.

It is an object of the present invention to provide a separator apparatus that includes a separator unit of novel design for separating pairs of adjacent teeth of a patient to facilitate the later placement of an anchor molar band between the teeth.

Another object of the invention is to provide a separator unit of the aforementioned character that is considerably easier to install and remove than conventional prior art separators.

Another object of the invention is to provide a novel separator unit that is comfortable when in place within the patient's mouth and one that does not interfere with the patient's bite.

Another object of the invention is to provide a separator unit of the class described that is reliable in use, exhibits relatively long life and one that does not tear, wear, or otherwise fail under the pressure of the patient's bite.

Another object of the invention is to provide a separator unit of the character described that is hygienic, durable in use and one that does not deteriorate in the patient's mouth as a function of time.

Another object of the invention is to provide a separator apparatus of the type described in the preceding paragraphs that includes a novel mechanism for installing the separator unit within the patient's mouth that is easy to manipulate and one that can be used effectively for the expeditious placement and removal of separator units within the patient's mouth with minimal patient discomfort.

Another object of the invention is to provide an installation mechanism of the character described in the preceding paragraph that is of simple construction and one that does not require special skills to operate.

Another object of the invention is to provide an installation mechanism of the class described that is of compact design and one that can be easily used with minimal patient discomfort even with patients having very small mouths, such as children.

The foregoing, as well as other objectives are realized by the apparatus described in the paragraphs that follow.

### BRIEF DESCRIPTION OF THE DRAWINGS

FIG. 1 is a generally perspective, exploded view of one form of the separator apparatus of the invention for separating adjacent teeth.

FIG. 2 is a generally perspective, fragmentary view of the foreword portion of the apparatus of FIG. 1 illustrating the connector arms of the apparatus in a spaced apart configuration.

FIG. 3 is a generally perspective view of one form of the separator unit of the invention in an at rest configuration.

FIG. 4 is a generally perspective view, similar to FIG. 3, but showing the coils of the separator unit in a spaced apart configuration.

FIG. 5 is a generally perspective view of an alternate form of separator unit of the invention in an at rest configuration.

FIG. 6 is a generally perspective view, similar to FIG. 5, but showing the coils of the alternate form of separator unit in a spaced apart configuration.

FIG. 7 is an enlarged, fragmentary top plan view of the separator mechanism of the separator apparatus shown in FIG. 1.

FIG. 8 is an enlarged, fragmentary bottom plan view of the separator mechanism of the separator apparatus illustrated in FIG. 1, showing in dotted lines movement of the lower arm into a second position.

FIG. 8A is an exploded view of the separator mechanism, partly in cross-section, taken along lines 8A-8A of FIG. 8.

FIG. 9 is a generally perspective diagrammatic view illustrating the operation of the separator apparatus shown in FIG. 1 in position to position one of the separator units between two adjacent teeth.

FIG. 10 is an enlarged, top plan view illustrating the appearance of the separator unit after it has been positioned between two adjacent teeth.

FIG. 11 is a generally perspective, fragmentary view of the end portions of the connector arms of the separator mechanism of the invention shown in FIG. 1.

FIG. 12 is a generally perspective, fragmentary view of the end portions of the connector arms of an alternate form of the separator mechanism of the invention.

FIG. 13 is a generally perspective, fragmentary view of the end portions of the connector arms of still another form of the separator mechanism of the invention.

FIG. 14 is a generally perspective view of yet another form of the separator mechanism of the separator apparatus of the invention for separating adjacent teeth.

FIG. 15 is a generally perspective, exploded view of still another form of the separator mechanism of the separator apparatus of the invention for separating adjacent teeth illustrating the use of a bite down pad affixed to the end portions of the connector arms of the separator mechanism.

FIG. 16 is a generally perspective view of yet another embodiment of the invention.

### DESCRIPTION OF THE INVENTION

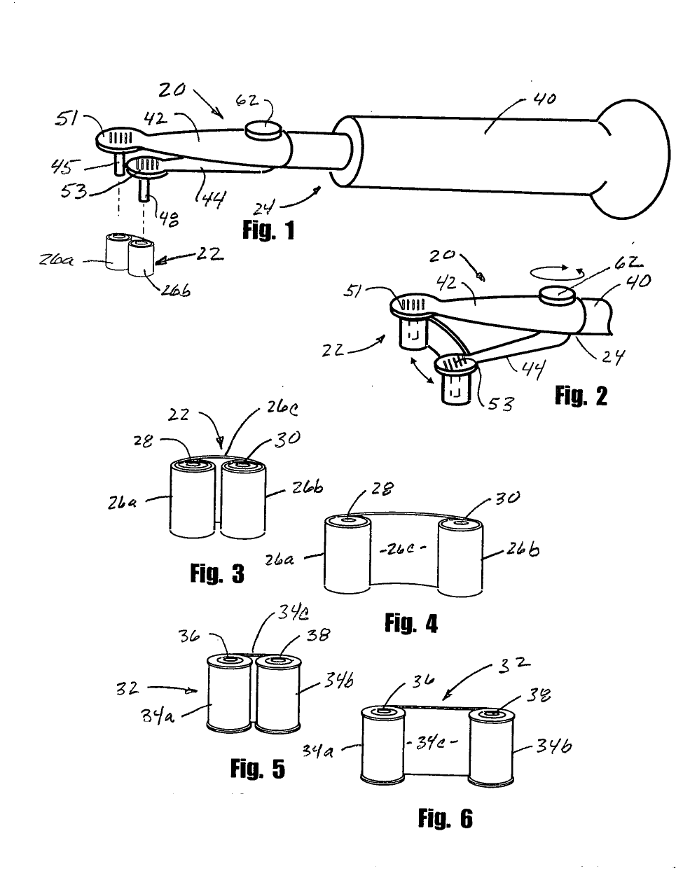

Referring to the drawings and particularly to FIGS. 1 and 2, one form of the separator apparatus of the invention is there shown and generally identified by the numeral 20. Apparatus 20 here comprises two cooperating components, namely a separator unit 22 and a coil separator mechanism 24. As best seen in FIGS. 3 and 4, separator unit 22 comprises a length of separator material 26 having a first coiled end portion 26a, a second coiled end portion 26b and an intermediate portion 26c. First coiled end portion 26a has a first axial bore 28 and is movable from the first coiled position shown in FIG. 3 to the second uncoiled position shown in FIG. 4. Similarly, second coiled end portion 26b has a second axial bore 30 and is movable from the first coiled position shown in FIG. 3 to the second uncoiled position shown in FIG. 4.

In the form of the separator unit shown in FIGS. 3 and 4, the separator material 26 comprises a pre-stressed stainless steel strip that exerts a restraining force that resists the uncoiling of the first and second end portions 26a and 26b.

In the alternate form of the separator unit 32 shown in FIGS. 5 and 6 of the drawings, the separator material, there identified by the numeral 34, comprises a commercially available, semi rigid latex rubber. Like separator material 26, separator material 34 tends to return to its coiled condition after being uncoiled.

As illustrated in FIGS. 5 and 6, separator material 34 has a first coiled end portion 34a, a second coiled end portion 34b and an intermediate portion 34c. First coiled end portion 34a has a first axial bore 36 and is movable from the first coiled position shown in FIG. 5 to the second uncoiled position shown in FIG. 6. Similarly, second coiled end portion 34b has a second axial bore 38 and is movable from the first coiled position shown in FIG. 5 to the second uncoiled position shown in FIG. 6.

Considering once again the important separator mechanism 24, in the present form of the invention, this novel mechanism functions to selectively act upon separator units 22 and 32 in a manner to move the first coiled end portions thereof from their first position to their second position to cause the first coiled end portions to uncoil and for moving the second coiled end portions thereof from their first position to their second position to cause their second coiled end portion to uncoil.

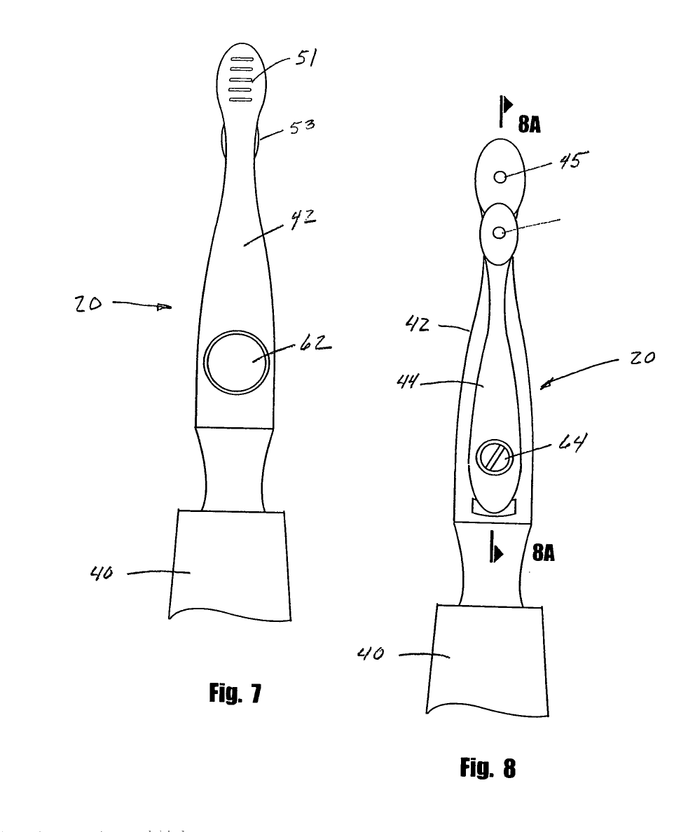

As best seen in FIGS. 1, 2, 7, 8 and 8A, coil separator mechanism 24 here comprises a generally tubular shaped gripping portion 40, a first smaller diameter arm 42 connected to gripping portion 40 and extending there from and a second smaller diameter arm 44 that is pivotally connected to arm 42 for movement between the first position shown in FIG. 1 and the second position shown in FIG. 2. As shown in FIGS. 2 and 3, first arm 42 is provided with a downwardly extending first connector pin 45 that is releasably engagable with the first coiled end portion 26a of the separator material 26. Similarly, second arm 44 is provided with a downwardly extending second connector pin 48 that is releasably engagable with the second coiled end portion 26b of the separator material 26. More particularly, first connector pin 45 is removably receivable within the first axial bore 28 of the first coiled end portion of said separator material of the separator unit, while connector pin 48 is removably receivable within the second axial bore 30 of the second coiled end portion of the separator material of said separator unit.

As seen in FIG. 2 of the drawings first and second arms 42 and 44 include flat end portions and 51 and 53, respectively that are adapted to be engaged by the teeth of the patient to impart a downward force on the arms to uniformly urge the separator material between the adjacent teeth of the patient.

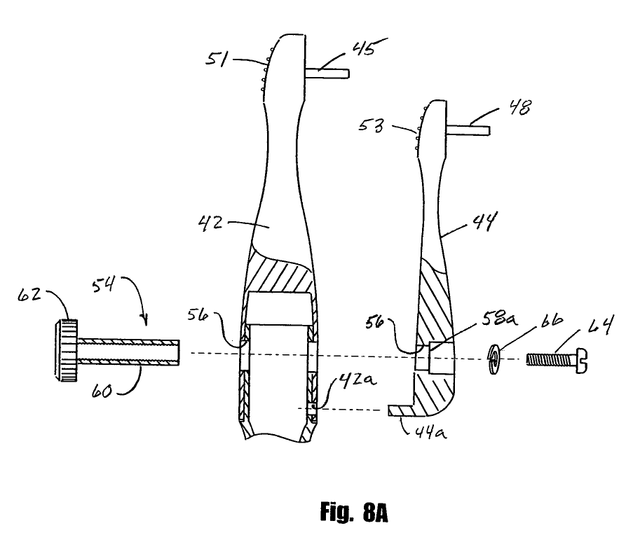

In order to controllably rotate second arm 44 relative to first arm 42, a control mechanism, generally designated by the numeral 54, is provided. Referring particularly to FIG. 8A of the drawings, it is to be noted that first arm 42 has a first bore 56 there through and second arm 44 has a second bore 58 there through. For a purpose presently to be described, second bore 58 has an internal shoulder 58a.

In the present form of the invention, control mechanism 54 comprises an internally threaded shaft 60 that is rotatably receivable within first bore 56. Connected proximate the outboard end of shaft 60 is a knurled, finger engaging knob 62 for gripping by the fingers of the practitioner to impart rotation to the internally threaded shaft 60. Also forming a part of the control mechanism 54 is an externally threaded screw 64 and a lock washer 66 that is received over threaded screw 64 in the manner indicated in FIG. 8A. Externally threaded screw 64 is receivable within the second bore 58 of said second arm 44 and is threadably received within internally threaded shaft 60. With this construction, upon rotation of the internally threaded shaft 60 within bore 56, lock washer 66 will move into locking engagement with internal shoulder 58a so that continued rotation of threaded shaft 60 will cause movement of second arm 54 from the first position shown in FIG. 1 of the drawings to the second position shown in FIG. 2.

A finger 44a, which protrudes from the lower portion of arm 44, is receivable within a slot 42a of arm 42 and functions to limit the extent of rotation of second arm 42.

In using the apparatus of the form of the invention shown in FIGS. 1 and 2 of the drawings, with the first and second arms in the position shown in FIG. 1 and with the separator unit in the at rest configuration shown in FIGS. 1 and 3, pins 45 and 48 are inserted within the bores 28 and 30 respectively of the separator unit 22 (see FIG. 9). This done, as illustrated in FIGS. 2 and 9, rotation of finger engaging knob 62 will move second arm 44 from the closed position shown in FIG. 1 to the open position shown in FIG. 2 and in so doing will move the separator unit 22 from the rest of the configuration into the uncoiled configuration shown in FIGS. 2 and 4 of the drawings.

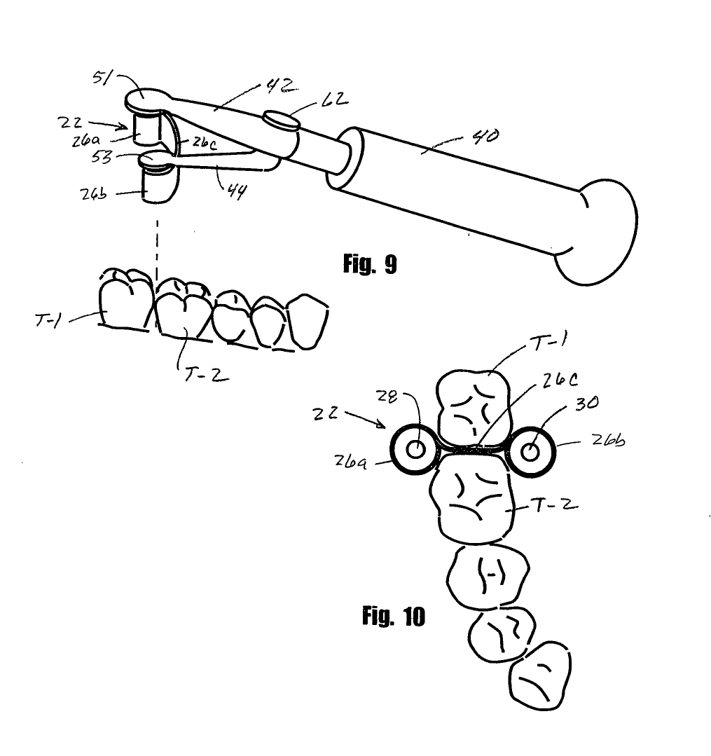

With the separator unit in the uncoiled configuration shown in FIGS. 2 and 9, the central portion 26c of the separator unit can be quickly and easily positioned between the adjacent teeth of a selected pair of teeth T-1 and T-2 (See FIGS. 9 and 10). With the central portion 26c of the separator unit in this position, as the patient bites down on the flats 51 and 53 provided proximate the ends of the first and second arms, the central portion of the separator unit will be uniformly urged downwardly between the patients teeth in the manner shown in FIG. 10, thereby separating the teeth by a distance equal to the width of the separator material.

With the separator unit positioned in the manner shown in FIG. 10, an upward force exerted on the first and second arms of the separator mechanism will allow the pins 45 and 48 to be removed from the bores 28 and 30 formed in the separator unit 22. Upon removal of the pins, the ends 26a and 26b of the separator unit will tend to return to their coiled position and, in the manner shown in FIG. 10 of the drawings, move into engagement with the teeth T-1 and T-2 in a manner to secure the separator unit 22 in position within the patient's mouth and uniformly separate teeth T-1 and T-2 by the required distance.

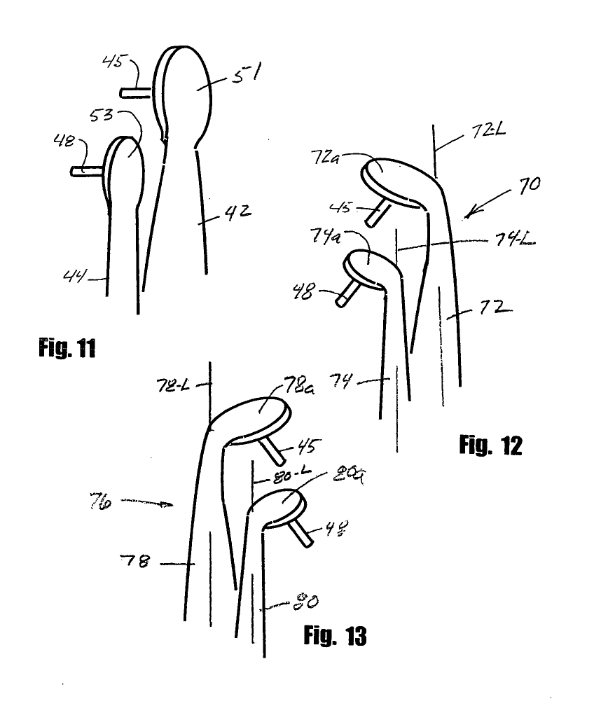

Turning now to FIGS. 11, 12 and 13 of the drawings, FIG. 11 shows the embodiment of the invention discussed in the preceding paragraphs wherein the end portions of the arms 42 and 44 are generally co-planar and, as shown in FIG. 1, reside in a generally horizontal plane. This embodiment of the invention is ideally suited for straight-on insertion of the separator unit between the patient's teeth.

FIG. 12 of the drawings illustrates an alternate embodiment of the invention, generally designated by the numeral 70. The construction and operation of this embodiment is similar in many respects to that of the earlier described embodiment of the invention and like numerals are used in FIG. 12 to identify like components. The primary difference between this latest embodiment of the invention and the earlier described embodiments resides in the fact that the end of portions 72a and 74a of the device arms 72 and 74 reside in a downwardly angled plane and are rotated to the left with respect to the longitudinal axis 72-L and 74-L of the arms 72 and 74. This embodiment of the invention is ideally suited for accessing the left posterior area of the patient's mouth. With the end portions of the arms angled in the manner shown in FIG. 12 of the drawings, the end portions do not present a visual obstruction to emplacement of the separator units in this portion of the patients mouth and, at the same time, make it easier to emplace the separator units between the adjacent teeth of the patient in this portion of the patients mouth.

FIG. 13 of the drawings illustrates still another form of the invention, which is there generally designated by the numeral 76. The construction and operation of this latest embodiment is also similar in many respects to that of the earlier described embodiment of the invention shown in FIGS. 1 through 10 and like numerals are used in FIG. 13 to identify like components. The primary difference between this latest embodiment of the invention and the earlier described embodiments resides in the fact that the end of portions 78a and 80a of the device arms 78 and 80 reside in a downwardly angled plane and are rotated to the right with respect to the longitudinal axis 78-L and 80-L of the arms 78 and 80. This latest embodiment of the invention is ideally suited for accessing the right posterior area of the patient's mouth. With the end portions of the arms angled in the manner shown in FIG. 13 of the drawings, the end portions do not present a visual obstruction to emplacement of the separator units in this right posterior portion of the patients mouth and at the same time make it easier to emplace the separator units between the adjacent teeth of the patient in this portion of the patients mouth.

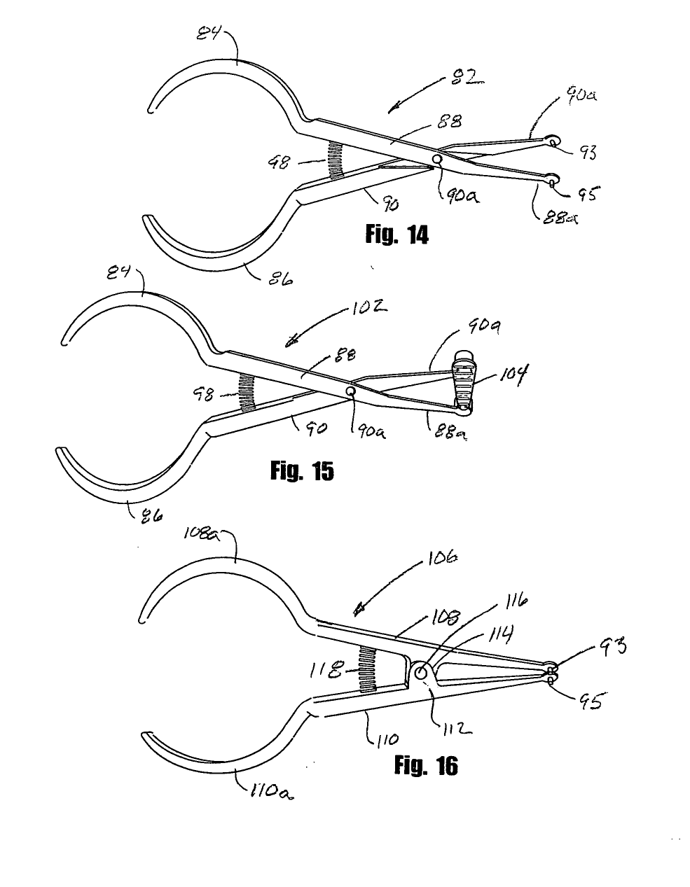

Referring next to FIG. 14 of the drawings, another form of coil separator mechanism of the invention is there illustrated and generally identified by the numeral 82. This latest form of coil separator mechanism, which is used to manipulate separator units of the character illustrated in FIGS. 3 through 6 of the drawings, is somewhat similar in construction and operation to the coil separator mechanism shown in FIGS. 1 through 10 of the drawings. Coil separator mechanism 82 here comprises a pliers-like mechanism having first and second pivotally interconnected, curved gripping portions 84 and 86. Connected to gripping portions 84 is an outwardly extending first arm 88 having an end portion 88a. Connected to gripping portion 86 is an outwardly extending second arm 90 having an end portion 90a. First arm 88 is provided with a downwardly extending first connector pin 93 that is releasably engagable with the first coiled end portion 26a of the separator material 26. Similarly, second arm 90 which is pivotally connected to first arm 88 by a pivot pin 90a, is provided with a downwardly extending second connector pin 95 that is releasably engagable with the second coiled end portion 26b of the separator material 26. More particularly, first connector pin 93 is removably receivable within the first axial bore 28 of the first coiled end portion of said separator material of the separator unit, while connector pin 95 is removably receivable within the second axial bore 30 of the second coiled end portion of the separator material of said separator unit.

As indicated in the drawings, arm 90 is a movable between the first position shown in FIG. 14 and a second closed position. In this latest form of the invention, biasing means shown here as a coil spring 98, which is disposed between gripping portions 84 and 86, functions to continuously urge the arms toward their open position.

In using the apparatus of the form of the invention shown in FIG. 14 of the drawings, with the first and second arms 88 and 90 of the coil separation mechanism in a partially closed position and with the separator unit in the at rest configuration shown in FIGS. 1 and 3, pins 93 and 95 can be inserted into bores 28 and 30 of the separator unit 22. This done, by exerting a pressure on the gripping portions 84 and 86 against the urging of spring 98, the first and second end portions of the arms, along with pins 93 and 95, will be moved from the partially closed position to a fully open position shown and in so doing will move the separator unit 22 from the rest of the configuration into the uncoiled configuration shown in FIG. 4 of the drawings. With the separator unit in the uncoiled figuration, the central portion 26c of the separator unit can be quickly and easily positioned between the adjacent teeth of a selected pair of teeth.

With the separator unit thusly positioned, an upward force exerted on the first and second arms will allow the pins 93 and 95 to be removed from the bores 28 and 30 formed in the separator unit 22. Upon removal of the pins, the ends 26a and 26b of the separator unit will tend to return to their coiled position and, as before, move into engagement with the teeth in a manner to secure the separator unit 22 in position within the patient's mouth.

Referring to FIG. 15 of the drawings, yet another form of coil separator mechanism of the invention is there illustrated and generally identified by the numeral 102. This latest form of coil separator mechanism, which is also used to manipulate separator units of the character illustrated in FIGS. 3 through 6 of the drawings, is quite similar in construction and operation to the coil separator mechanism shown in FIG. 14 and like numerals are used in FIG. 15 to identify like components. The primary difference between the embodiment of the invention shown in FIG. 15 and that shown in FIG. 14 resides in the fact that a bite down pad 104 is connected to, and spans the end portions 88a and 90a of, first and second arms 88 and 90. With this construction, with the separator material initially introduced between the adjacent teeth of the patient in a manner previously described, the patient can be instructed to bite down on the bite down pad 104 and in so doing urge the separator material downwardly between the teeth. The pins 93 and 95 can then be removed from the separator unit in the manner previously described so as to allow the separator unit to return toward its at rest position with the end coils of the unit in engagement with the teeth of the patient in a manner shown in FIG. 10 of the drawings.

Referring to FIG. 16 of the drawings, still another form of coil separator mechanism of the invention is there illustrated and generally identified by the numeral 106. This latest form of coil separator mechanism, which is also used to manipulate separator units of the character illustrated in FIGS. 3 through 6 of the drawings, is quite similar in construction and operation to the coil separator mechanism shown in FIG. 14 and like numerals are used in FIG. 16 to identify like components. The primary differences between the embodiment of the invention shown in FIG. 16 and that shown in FIG. 14 reside in the provision of a differently acting spring and the fact that the first and second arms 108 and 110 of the separator mechanism are pivotally interconnected in a slightly different manner. More particularly, second arm 110 includes a pair of spaced apart connector members 112 within which a connector protuberance 114 formed on arm 108 is closely received. A pivot pin 116 extends through members 112 and protuberance 114 and functions to pivotally interconnect arms 108 and 110. While in this latest form of the invention a coil spring 118 is disposed between arms 108 and 110 and functions to bias the arms toward the closed position shown in FIG. 16 of the drawings.

As in the earlier described embodiments, first arm 108 includes a gripping portion 108a and is provided with a downwardly extending first connector pin 93 that is releasably engagable with the first coiled end portion 26a of the separator material 26. Similarly, second arm 110 includes a gripping portion 10a and is provided with a downwardly extending second connector pin 95 that is releasably engagable with the second coiled end portion 26b of the separator material 26. More particularly, first connector pin 93 is removably receivable within the first axial bore 28 of the first coiled end portion of said separator material of the separator unit, while connector pin 95 is removably receivable within the second axial bore 30 of the second coiled end portion of the separator material of said separator unit.

In using the apparatus of the form of the invention shown in FIG. 16 of the drawings, with the first and second arms 108 and 110 of the coil separation mechanism in the closed position shown in FIG. 16 and with the separator unit in the at rest configuration shown in FIGS. 1 and 3, pins 93 and 95 can be inserted into bores 28 and 30 of the separator unit 22 by exerting a force against gripping portions 108a and 110a against the urging of spring 118 tending to separate pins 93 and 95 a distance approximately equal to the distance between the bores. This done, pins 93 and 95 can be inserted into the bores 28 and 30 in a manner previously described. Then, by exerting a further pressure on the gripping portions 108a and 110a against the urging of spring 118, the end portions of the arms, along with pins 93 and 95, will be moved to a more fully open position and in so doing will move the separator unit 22 from the rest of the configuration into the uncoiled configuration shown in FIG. 4 of the drawings. With the separator unit in the uncoiled figuration, the central portion 26c of the separator unit can be quickly and easily positioned between the adjacent teeth of a selected pair of teeth.

With the separator unit thusly positioned, an upward force exerted on the first and second arms will allow the pins 93 and 95 to be removed from the bores 28 and 30 formed in the separator unit 22. Upon removal of the pins, the ends 26a and 26b of the separator unit will tend to return to their coiled position and, as before, move into engagement with the teeth in a manner to secure the separator unit 22 in position within the patient's mouth.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A separator unit for separating pairs of adjacent teeth of a patient comprising a length of separator material having a first coiled end portion, a second coiled end portion and an intermediate portion, said first and second end portions being movable from a first at rest position to a second, spaced apart partially uncoiled position.

2. The separator unit as defined in claim 1 in which said first and second end portions of said length of separator material are generally tubular shaped.

3. The unit as defined in claim 1 in which said separator material comprises a latex rubber.

4. The apparatus as defined in claim 1 in which said separator material comprises a pre-stressed metal that exerts a restraining force which resists uncoiling of said first and second end portions of said separator unit.

5. A separator apparatus for separating a pair of adjacent teeth of a patient comprising:
(a) a separator unit comprising a length of separator material having a first coiled end portion, a second coiled end portion and an intermediate portion, said first and second coiled end portions being movable from a first at rest position to a second, spaced apart partially uncoiled position; and
(b) a separator mechanism for moving said first and second coiled end portions of said separator unit from said first position to said second position.

6. The apparatus as defined in claim 5 in which said separator mechanism comprises:
(a) a gripping portion;
(b) a first arm connected to said gripping portion and extending therefrom, said first arm being releasably engagable with said first coiled end portion of said separator unit; and
(c) a second arm pivotally connected to said first arm for movement between first and second positions, said second arm being releasably engagable with said second coiled end portion of said separator unit.

7. The apparatus as defined in claim 5 in which said first and second coiled end portions of said separator unit are generally tubular shaped with each having an axial bore and in which said first arm has a first connector pin removably receivable within said axial bore of said first coiled end portion of said separator unit and in which said second arm has a second connector pin removably receivable within said axial bore of said second coiled end portion of said separator unit.

8. The unit as defined in claim 5 in which said separator material of said separator unit comprises a latex rubber.

9. The apparatus as defined in claim 5 in which said separator material of said separator unit comprises a pre-stressed metal that exerts a restraining force which resists uncoiling of said first and second end portions of said separator unit.

10. A separator apparatus for treating a patient having a pair of adjacent teeth and a plurality of teeth opposing the pair of adjacent teeth, said apparatus comprising:
(a) a separator unit comprising a length of separator material having a first coiled end portion, a second coiled end portion and an intermediate portion, said first coiled end portion having a first axial bore and being movable from a first position to said second position and said second coiled end portion having a second axial bore and being movable from a first position to said second position; and
(b) a coil separator mechanism for moving said first coiled end portion from said first position to said second position to cause said first coiled end portion to uncoil and for moving said second coiled end portion from said first position to said second position to cause said second coiled end portion to uncoil.

11. The apparatus as defined in claim 10 in which said separator material of said separator unit comprises a latex rubber.

12. The apparatus as defined in claim 10 in which said separator material of said separator unit comprises a pre-stressed stainless steel strip that exerts a restraining force which resists uncoiling of said first and second end portions of said separator material of said separator unit.

13. The apparatus as defined in claim 10 in which said coil separator mechanism comprises:
(a) a gripping portion;
(b) a first arm connected to said gripping portion and extending therefrom, said first arm being releasably engagable with said first coiled end portion of said separator material of said separator unit; and
(c) a second arm pivotally connected to said first arm for movement between first and second positions, said second arm being releasably engagable with said second coiled end portion of said separator material of said separator unit.

14. The apparatus as defined in claim 13 further including a coil spring disposed between said first and second arms for yieldably resisting relative movement between said first and second arms.

15. The apparatus as defined in claim 13 further including a control mechanism operably associated with said first and second arms for moving said second arm between said first and second positions.

16. The apparatus as defined in claim 15 in which said first arm has a first bore there through, in which said second arm has a second bore there through, said second bore having an internal shoulder and in which said control mechanism comprises:
(a) a threaded shaft receivable within said first bore of said first arm for rotation therewith;
(b) a finger engaging knob connected to said threaded shaft;
(c) a threaded screw receivable within said second bore of said second arm, said threaded screw being threadably engaged with said threaded shaft; and
(d) a nut receivable over said threaded screw for engagement with said shoulder of said second bore upon rotation of said threaded shaft.

17. The apparatus as defined in claim 16 in which said first arm includes a first connector pin removably receivable within said first axial bore of said first coiled end portion of said separator material of said separator unit and in which said second arm has a second connector pin removably receivable within said second axial bore of said second coiled end portion of said separator material of said separator unit.

18. The apparatus as defined in claim 17 in which each of said first and second arms includes a flat end portion for engagement by the teeth of the patient to impart a force thereon to urge said separator material between the adjacent teeth of the patient.

19. The apparatus as defined in claim 18 in which each of said first and second arms has a longitudinal axis and in which said end portions of said first and second arms extend at an angle with respect to said longitudinal axis.

20. The apparatus as defined in claim 19 further including a bite down pad connected to and spanning said end portions of said first and second arms.
